(19) United States
(12) Patent Application Publication
(10) Pub. No.: US 2010/0287801 A1
(43) Pub. Date: Nov. 18, 2010

(54) LOCALIZED SEALANT APPLICATION IN AEROSTATS

(75) Inventors: Dean Scott Borchardt, River Falls, WI (US); Andrew Thomas Swanson, Shakopee, MN (US); Todd Richard Sarnstrom, SR., Ellsworth, WI (US); Jeffrey Jacob Cernohous, Hudson, WI (US); Garrett Scott Van Gorden, River Falls, WI (US)

Correspondence Address: BRIGGS AND MORGAN P.A., 2200 IDS CENTER, 80 SOUTH 8TH ST, MINNEAPOLIS, MN, 55402, US

(73) Assignee: Anagram International, Inc., Eden Prairie, MN (US)

(21) Appl. No.: 12/781,380

(22) Filed: May 17, 2010

Related U.S. Application Data
(60) Provisional application No. 61/179,124, filed on May 18, 2009.

(51) Int. Cl. G09F 21/06; B32B 38/04

(52) U.S. Cl. 40/212; 156/263

(57) ABSTRACT

Formation of an aerostat through the application of a pressure sensitive adhesive onto one or more barrier films at the desired point of bonding between the films. The adhesive is applied about the periphery prior to the point of bonding the two barrier films together. The method of the present invention results in aerostats with a bond line at the edge of the desired shape. The reduced weight, in comparison to conventional practices employing a heat sealing layer, enables intricate designs and smaller volume aerostats.

### CROSS-REFERENCE TO RELATED APPLICATION

This application claims priority from U.S. Provisional Patent Application Ser. No. 61/179,124 filed on May 18, 2009 entitled Localized Sealant Application in Aerostats.

### TECHNICAL FIELD

The present invention relates to an aerostat utilizing a differentiated bonding mechanism to enclose lighter than air gases between two or more barrier films.

### BACKGROUND OF THE INVENTION

Aerostats are objects using principles of aerostatics to float, i.e. lighter than air objects, such as balloons, that derive their lift from the buoyancy of surrounding air rather than from aerodynamic motion. According to Archimedes Principle, an object is buoyed up by a force equal to the weight of the fluid displaced by the object. For an aerostat, the buoyant force must be sufficient enough to overcome the total weight of the aerostat in order to float.

Aerostats generally consist of a relatively thin film material creating a volumetric body that contains a lighter than air gas to create buoyancy. Aerostats commonly employ helium as a lighter than air gas.

Novelty balloons are an example of aerostats that utilize thin polymeric films to create a volumetric body suitable for containing a lighter than air gas. The films are generally constructed to have a gas barrier layer on a carrier substrate and a sealant layer. The multilayered films are manufactured in a web format with conventional converting practices. The sealant layer enables the combination of two separate films to create a volumetric body by heat sealing the two films into a desired pattern. The polymeric films are optionally printed with fanciful art or greetings, prior to being mated with a second polymeric film. The two films are then heat sealed together and the article is cut along a periphery of the sealed area to create the article.

In order to enable the broad production of numerous designs and shapes on one mass produced polymeric film, the sealant layer is coated onto the polymeric film in both the crossweb and downweb direction. As a result, the articles created by the combination of the two polymeric films possess a sealant layer across the entirety of the article, with heat activated seals about its periphery.

### BRIEF SUMMARY OF THE INVENTION

The conventional practice of employing heat sealing layers on aerostats results in undesirable weight that can adversely impact the lifting capacity and ultimately limit the physical size of the aerostat. The present invention applies an adhesive onto one or more barrier films at the desired point of bonding between the films. This practice eliminates the need to utilize a heat sealant layer across the entirety of the film—a cost savings. The reduction of overall weight of the aerostat results in a corresponding increase in lifting capacity necessary for the aerostat to maintain aloft.

The method of applying an adhesive at the desired point of bonding can be accomplished by coating techniques such as flexographic printing, inkjet printing, roll transfer, or silk screening. The adhesive is applied about the periphery in most applications after the printing of desired art or greetings and just prior to the point of bonding the two barrier films together. In one embodiment, the adhesive is a radiation curable adhesive, such as a UV curable adhesive. Radiation curable adhesives, upon curing, are capable if achieving substantial bond strengths without excess adhesive material or the creation of large bonding seams, both of which could have negative impacts on the aerostat.

Additionally, the use an adhesive at the desired point of bonding enables the formation of aerostats with dimensionally smaller structures than those enabled by previous constructions. This is primarily due to the reduction in mass due to the elimination of a sealant layer. At least one embodiment permits the formation of an aerostat having an internal volume of greater than about 2000 cm³. That volume is significantly lower than those that are limited through the production of heat sealant layers.

In another embodiment, adhesives suitable for application at the point of bonding provide greater control in applying a minimal amount of adhesive yet attaining preferred bond strength. The greater control provides the ability to create greater variation in shapes for the end use article. Additionally, the radiation curable adhesives provide consistent, uninterrupted bonds. This is important to prevent leakage of the lighter than air gas.

The above summary of the present invention is not intended to describe each disclosed embodiment or every implementation of the preset invention. The detailed description that follows more particularly exemplifies illustrative embodiments.

### BRIEF DESCRIPTION OF DRAWINGS

FIG. 1 is a schematic of one process suitable for practicing the present invention.

FIG. 2 is a perspective view of the assembled aerostat according to this invention.

### DETAILED DESCRIPTION OF THE INVENTION

The present invention applies an adhesive onto one or more barrier films at the desired point of bonding between the films. The method of applying an adhesive at the desired point of bonding can be accomplished by coating techniques such as flexographic printing, inkjet printing, roll transfer, or silk screening techniques. The adhesive is applied about the periphery in some applications after the printing of desired art or graphics and just prior to the point of bonding the two barrier films together. The method of the present invention results in aerostats with a bond line at the edge of the desired shape. The reduced weight, in comparison to conventional practices employing a heat sealing layer, enables intricate designs and smaller volume aerostats.

Those of ordinary skill in the art of manufacturing aerostats, such as novelty balloons, recognize that barrier films are necessary to prevent the depletion of the lighter than air gas from the balloon. For purposes of the invention, a barrier film may possess an oxygen gas transmission rate of less than 0.15 cc/100 sq.in./day. The barrier films suitable for use in this application may include, for example, those disclosed in U.S. Pat. Appl. Publication Nos. 2007/0287017 and 2009/0022919, herein incorporated by reference in their entirety.

In one embodiment, the barrier film may be a polyamide, a polyester or a polyolefin based polymer, or combinations of such polymers. For example, a barrier film may be a lamination of a polyester film that includes a biaxially oriented polyester core layer and an amorphous copolyester skin layer. The barrier film may be clear, opaque, or it may be coated with an additional layer, such as a light reflecting layer.

Non-limiting examples of polyamide barrier films useful in this invention include nylon 4, nylon 4.6, nylon 6, nylon 6.6, nylon 6.10, nylon 6.12, nylon 11 and nylon 12.

In another embodiment, the barrier film may be a high crystalline polyester film achieved by bi-axial orientation. This crystallized portion of the film may contribute to making the film stiff and tear resistant during the balloon fabrication process, while remaining thin enough to make the balloon light.

Suitable polyesters may be a polymer obtained by polycondensation of a diol and a dicarboxylic acid. The dicarboxylic acids may include, for example, terephthalic acid, isophthalic acid, phthalic acid, naphthalenedicarboxylic acid, adipic acid and sebacic acid, and the diols may include, for example, ethylene glycol, trimethylene glycol, tetramethylene glycol and cyclohexane dimethanol.

The polyesters may include, for example, polymethylene terephthalate, polyethylene terephthalate, polypropylene terephthalate, polyethylene isophthalate, polytetramethylene terephthalate, polyethylene-p-oxybenzoate, poly-1,4-cyclohexylenedimethylene terephthalate and polyethylene-2,6-naphthalate.

These polyesters may be homopolymers and copolymers, and the co-monomers may include, for example, diols such as diethylene glycol, neopentyl glycol and polyalkylene glycols, dicarboxylic acids such as adipic acid, sebacic acid, phthalic acid, isophthalic acid and 2,6-naphthalenedicarboxylic acid, and hydroxycarboxylic acids such as hydroxybenzoic acid and 6-hydroxy-2-naphthoic acid.

Polyethylene terephthalate, and polyethylene naphthalate (polyethylene-2,6-naphthalate) may be used to achieve higher crystallinity. Further, the polyester may include various types of additives, for example, an antioxidant, a heat-resistant stabilizer, a weather-resistant stabilizer, an ultraviolet ray absorber, an organic slipperiness imparting agent, a pigment, a dye, organic or inorganic fine particles, a filler, an antistatic agent, a nucleating agent and the like.

In certain embodiments, multiple layer barrier films may be utilized. Multiple layer films may include coextruded layers with at least one layer being an amorphous polymer. Those of ordinary skill in the art are capable of selecting polymeric compositions for multiple layer applications to achieve specific barrier properties.

Non-limiting examples of polyolefin barrier films useful in this invention include biaxially oriented polypropylene and high density polyethylene.

The barrier layer may also include a metalized or ceramic layer bonded to a polyamide, polyester or polyolefin substrate. For example, a metalized layer such as aluminum, or a ceramic deposition layer such as SiOx and AlOx may be suitable for use with the present invention. The metalizing layer or ceramic deposition layer may be applied using any available deposition method such as physical vapor deposition or chemical vapor deposition. The metalizing layer may be deposited to a thickness of greater than 20 nanometers. Those of ordinary skill in the art of vapor deposition are capable of selecting an appropriate composition and technique to create a suitable barrier layer for the present invention.

Suitable barrier films may generally include, but are not limited to, olefin-based, polyester, nylon, polypropylene, biopolymer polylactic acid (PLA) and the like as well as bio-based polymer polyhydroxy butyrate-valerate (PHBV).

Other biodegradable films may be utilized in this invention. Biodegradable films are comprised of one or more biodegradable polymers. Biodegradable films of this invention are produced by melt processing biodegradable polymers into thin films. This can be done using conventional melt processing techniques useful for producing thin films. Non-limiting examples of melt processing techniques useful for producing films include cast and blown film extrusion.

The biodegradable polymers may include those polymers generally recognized by those of ordinary skill in the art to decompose into compounds having lower molecular weights. Non-limiting examples of biodegradable polymers suitable for practicing the present invention include polysaccharides, peptides, aliphatic polyesters, polyamino acids, polyvinyl alcohol, polyamides, polyalkylene glycols, and copolymers thereof.

In one aspect the, the biodegradable polymer is a linear polyester. Non-limiting examples of linear polyesters include polylactic acids, poly-L-lactic acid (PLA), and a random copolymer of L-lactic acid and D-lactic acid, and derivatives thereof. Other non-limiting examples of polyesters include polycaprolactone, polyhydroxybutyric acid, polyhydroxyvaleric acid, polyethylene succinate, polybutylene succinate, polybutylene adipate, polymalic acid, polyglycolic acid, polysuccinate, polyoxalate, polybutylene diglycolate, and polydioxanone.

The thickness of the barrier film may range up to about 50 micrometers, suitably 0.18 to 2 mils and ideally 0.36 to 0.48 mils. The materials of construction for the barrier layer, the thickness of the materials employed, the desired shape of the article, should be selected by one of ordinary skill in the art to achieve a desired float time for the aerostat.

The aerostat, and in particular balloons for novelty applications, may optionally include aesthetic layer(s), such as, graphics, indicia, print, fanciful art or alphanumeric characters applied onto an exposed surface of the article. Flexographic printing is one means for applying such aesthetic layer or layers. The printing equipment used in this process may be set up in a manner that will prevent scratching, scuffing or abrading the gas barrier surface.

Various adhesives may be applied onto an edge of the barrier films to form a bond between the barrier films. The adhesive thicknesses may range up to about 2.5 mils and ideally 0.75 to 1.25 mils. In some embodiments, the seal width, as determined by the application of the radiation curable adhesive, is about 1/32 of an inch, and more preferably 1/16 of an inch and even more preferably ⅛ of an inch.

Adhesives suitable for application on aerostats include radiation curable adhesive formulations. Preferred adhesives have the ability to provide excellent adhesion performance to effectively seal two barrier films. Radiation curable pressure sensitive adhesives (“PSA's”) are examples of a one class of adhesives useful in this invention. Curing such adhesives may also take place by heat, air, time, electronic beam, ultraviolet, or ultrasonic means. The replacement of the sealant layer with the adhesives of the present invention significantly enhances the ability of those skilled in the art of balloon manufacturing to (i) create unique designs due to the reduced overall weight of the construction, and (ii) improve the efficiency of the manufacturing process by providing greater control for the application of the adhesive and the sealing process. With respect to unique designs, the reduction of weight enables the designer to develop constructions for smaller volume balloons that were previously not available due to buoyancy constraints related to the mass of the structure. Regarding the improved efficiency, the manufacturer is now able to place the adhesive in desired areas without the concern of exposure to potentially excessive heat that can widen a bonding seam or adversely affect the barrier layer.

In one embodiment, the adhesive is a radiation curable adhesive, such as a UV curable polymer. Any conventionally recognized radiation curable adhesives are suitable for use with the present invention. The radiation curable adhesive may be applied, for example, with printing techniques. Non-limiting examples of radiation curable adhesives include Acrylic polymers or copolymers, methacrylic polymers and copolymers, or combinations thereof. In a preferred embodiment, the radiation curable adhesives of this invention exhibit pressure sensitive characteristics. Pressure sensitive adhesive compositions are well known to those skilled in the art to possess properties that include: (a) aggressive and permanent tack; (b) adherence with no more than finger pressure; (c) sufficient ability to hold onto an adherend; and (d) sufficient cohesive strength. Certain PSA's can also be removed cleanly from its original target substrate. Materials that have been found to function well as PSA's include polymers designed and formulated to exhibit the requisite viscoelastic properties resulting in a desired balance of tack, peel adhesion and shear holding power. In some embodiments of this invention, the pressure sensitive adhesive provides a permanent bond to seal two barrier films and form the aerostat.

A wide variety of acrylate copolymers can be used and are known in the polymer and adhesive arts, as are methods of preparing the monomers and polymers. Acrylate copolymers are generally prepared by polymerizing (meth)acrylate monomers, e.g., polymers prepared from one or more (meth)acrylate monomers, optionally with any one or more of a variety of other useful monomers; where “(meth)acrylate” monomer is used to refer collectively to acrylate and methacrylate monomers. The copolymers can be present in combination with other, non-(meth)acrylate, e.g., vinyl-unsaturated, monomers. Suitable acrylate copolymers include, but are not limited to, 2-ethyl hexyl acrylate/acrylic acid (2-EHA/AA) copolymers. The acrylate copolymers can include optional crosslinkers such as, for example, bis-aziridines or multi-functional acrylates or methacrylates. Non-limiting examples of useful monomers for the radiation curable adhesive formulation of this invention include:
1) acrylic acid esters of an alkyl alcohol (preferably a non-tertiary alcohol), the alcohol containing from 1 to 14 (preferably from 4 to 14) carbon atoms and include, for example, methyl acrylate, ethyl acrylate, n-butyl acrylate, t-butyl acrylate, hexyl acrylate, isooctyl acrylate, 2-ethylhexyl acrylate, isononyl acrylate, isobornyl acrylate, phenoxyethyl acrylate, decyl acrylate, and dodecyl acrylate;
2) methacrylic acid esters of an alkyl alcohol (preferably a non-tertiary alcohol), the alcohol containing from 1 to 14 (preferably from 4 to 14) carbon atoms and include, for example, methyl methacrylate, ethyl methacrylate, n-propyl methacrylate, n-butyl methacrylate, isobutyl methacrylate and t-butyl methacrylate;
3) (meth)acrylic acid monoesters of polyhydroxy alkyl alcohols such as 1,2-ethanediol, 1,2-propanediol, 1,3-propane diol, the various butyl diols, the various hexanediols, glycerol, such that the resulting esters are referred to as hydroxyalkyl (meth)acrylates; 4) multifunctional (meth)acrylate esters such as 1,4-butanediol diacrylate, 1,6-hexanediol diacrylate, glycerol diacrylate, glycerol triacrylate, and neopentyl glycol diacrylate although these monomers are generally not preferred for reactive extrusion or melt blending;
5) macromeric (meth)acrylates such as (meth)acrylate-terminated styrene oligomers and (meth)acrylate-terminated polyethers, such as are described in PCT Patent Application WO 84/03837 and European Patent Application EP 140941;
6) (meth)acrylic acids and their salts with alkali metals, including, for example, lithium, sodium, and potassium, and their salts with alkaline earth metals, including, for example, magnesium, calcium, strontium, and barium

An acrylate or methacrylate copolymer is formed by exposure to radiation. In a one embodiment, the radiation is near visible or UV light. At least one free radical initiator is included in the adhesive composition of the invention to initiate the polymerization, and thereby form a permanent bond. Free radical initiators, such as photoinitiators that are useful for reacting or polymerizing acrylate materials are well understood, as are their use and the amounts to be included in an adhesive as described herein. Exemplary free radical photoinitiators useful for this invention include the benzoin ethers, such as benzoin methyl ether or benzoin isopropyl ether, substituted benzoin ethers, such as anisoin methyl ether, substituted acetophenones, such as 2,2-diethoxyacetophenone and 2,2-dimethoxy-2-phenylacetophenone, substituted alpha-ketols, such as 2-methyl-2-hydroxypropiophenone, aromatic sulfonyl chlorides, such as 2-naphthalene-sulfonyl chloride, and photoactive oximes, such as 1-phenyl-1,2-propanedione-2(O-ethoxycarbonyl)oxime. Suitable free radical photoinitiators for use in the compositions of the invention, include, but are not limited to, commercially available compounds such as Irgacure 651 and 819 (CIBA Specialty Chemicals Corp.; Tarrytown, N.J.).

The amount of free radical initiator can be sufficient to cause polymerization of the adhesive composition. In one embodiment, the amount of initiator can be in the range from a number about 0.01 to about 2 parts by weight free radical initiator for one hundred parts by weight total adhesive composition, with the range from about 0.05 to about 1 parts by weight being preferred.

Optional components that can be included in adhesive compositions of the invention include, for example, photosensitizers, grafting agents, crosslinkers, tackifiers, reinforcing agents, and other modifiers (e.g. plasticizers). Photosensitizers can be used to alter the wavelength sensitivity of a photoinitiator. A grafting agent can be copolymerized into the polymer backbone to impart improved crosslinking efficiency. For example, a grafting agent such as 4-Acryloxy Benzophenone (ABP) can generate free radicals on the acrylate copolymer backbone, which can subsequently crosslink the system.

A crosslinker can be included in the adhesive in a useful amount that may improve properties of the adhesive, such as by crosslinking the acrylate copolymer. Such amounts are conventionally recognized and understood by those having ordinary skilled in the art. Exemplary amounts of crosslinker can be in the range from about 0 to about 10 percent by weight, with preferred amounts being in the range from about 0.1 to about 5 percent by weight. Amounts outside of this range can also be useful, with a particular amount of crosslinker for any adhesive composition depending on a number of various factors including the chemistry of the crosslinker, the chemistry of the acrylate copolymer, and the desired properties of the cured and uncured adhesive. Exemplary classes of useful crosslinkers are bis-aziridines and multi-functional acrylates.

Cured adhesive compositions according to the invention can provide “permanent” seal properties for the aerostat. In embodiments of the invention, a cured adhesive exhibits a seal strength of greater than about 2000 g/in, when measured using tests described in the test methods below. Greater strengths can also be achieved by modifying components and their respective concentrations, for example, seal strengths greater than about 6000 Win can be obtained.

In another embodiment, the radiation curable adhesive formulation is self priming by incorporating an adhesion promoting additive. The function of the adhesive promoting additive is to improve the bond of the radiation curable adhesive to the barrier film. Non-limiting examples of adhesion promoting additives include functional alkoxyslianes and functional acrylates. In both instances, these molecules have functionality that imparts improved adhesion to the barrier film while having affinity to the radiation curable monomer or polymer composition. In a preferred embodiment, the adhesion promoting additive is capable of covalently bonding to the adhesive composition.

An optional valve 16 for the insertion of the lighter than air gas is commonly placed between the first barrier film and the second barrier film. Conventionally recognized valves suitable for the insertion of a lighter than air gas may be employed in conjunction with the aerostat. For example, a self-sealing, flexible valves such as those described in U.S. Pat. No. 4,917,646 and U.S. application Ser. No. 12/079,799 filed Mar. 28, 2008 both for balloon valves and herein incorporated by reference in their entirety, may be utilized. Those of ordinary skill in the art are capable of selecting a particular valve depending upon the desired application.

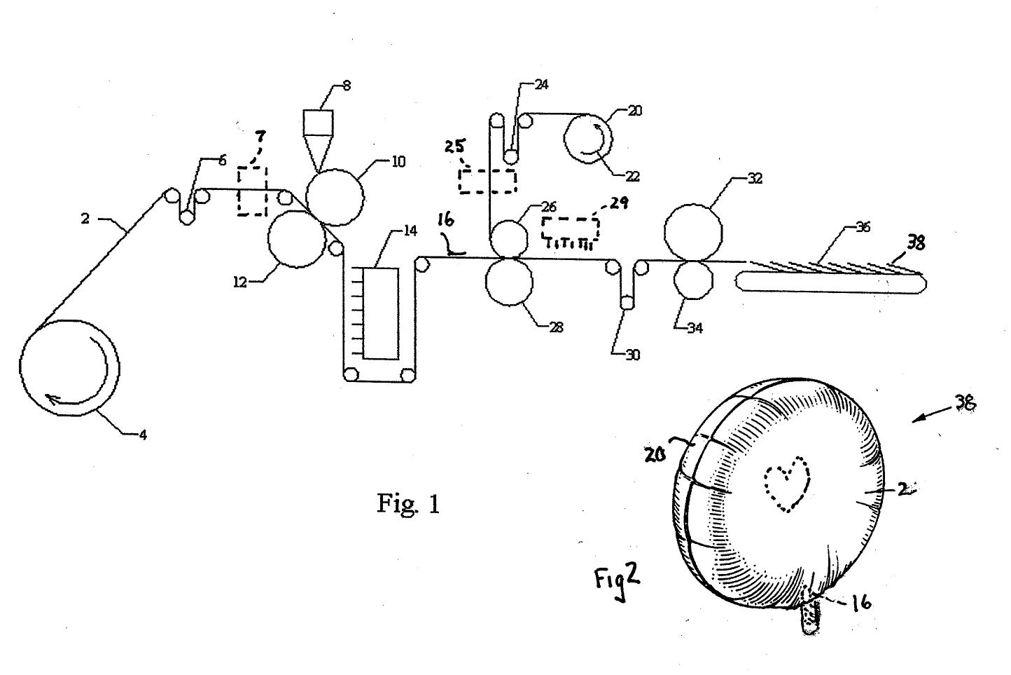

FIG. 1. depicts one method of the present invention suitable for making balloons 38 (shown in FIG. 2) from two separate barrier films. A first barrier film 2 is placed on an unwinding station 4 where the film 2 is conveyed through a registration station 6 and an optional printing station 7, as is known, to apply a desired aesthetic design. A valve (not shown) is then applied onto film 2 so that it will be affixed between barrier films 2, 20. A radiation curable adhesive 8 is then printed onto first barrier film 2 through a print roller 10 and impression roller 12. The radiation curable adhesive is subsequently irradiated at UV curing station 14 prior to coming into contact with a second barrier film 20. Alternatively, curing could take place after lamination at station 29. Concurrently, the second barrier film 20 is conveyed from unwinding station 22 through a registration station 24 and an optional printing station 25. The first barrier film 2 and the second barrier film 22 are then conveyed through a laminating station with nip roller 26 and compression roller 28 to form a bond between films 2, 20. The design is then die cut at die cutting station 32 and compression roller 34. The finished object is removed from the laminated films by conventional pick and place equipment (not shown) at finished product station 36 to create an uninflated balloon 38.

In certain embodiments, the aerostats may have an oxygen transmission rate of less than 0.15 cc/100 sqin/day, a sealing strength of the seam on the aerostat of more than 2000 Win, and a floating time of the article in air at standard sea level conditions is more than 48 hours. Additionally, certain embodiments may result in relatively small volumetric designs such as aerostats having an internal volume of less than about 2000 cm³

Oxygen transmission rates are measured using a MOCON Ox-Tran L series device utilizing ASTM D3985 with test conditions of 73° F. and 0% RH at 1 ATM.

Seal strength uses a modified ASTM F88 test standard. The sealed materials are cut so that each web can be gripped in a separate jaw of the tensile tester and 1″×⅜″ section of sealed material can be peeled apart on an Intron tensile tester in an unsupported 90° configuration. Initial grip separation is at 4 inches with a preload rate of 2 in/min until 0.5 lbs of resistance reached. Tensile force is continued at a rate of 6 in/min until the load drops by 20% of the maximum load, signaling failure. The maximum recorded load prior to failure is reported as the seal strength.

Floating time of the aerostat is determined by inflating it with helium gas and measuring the number of days that the aerostat remains fully inflated. An aerostat is filled from a helium source using a pressure regulated nozzle designed for “foil” balloons, such as the Conwin Precision Plus balloon inflation regulator and nozzle. The pressure should be regulated to 16 inches of water column pressure with an auto shut off. The aerostat should be filled with helium in ambient conditions of about 70 degrees F. temperature until the internal pressure of the aerostat reaches 16 inches of water column and the regulator shuts off. The aerostat should be tethered below the aerostat's valve access hole to avoid distorting or damaging the valve thus creating slow leaks of helium gas through the valve. During the testing the aerostat should be kept in a stable environment close to the ambient conditions stated. Changes in temperature and barometric pressure should be recorded to interpret float time results, as any major fluctuations can invalidate the test. The aerostat is observed over the course of the test for the appearance of fullness. One judgment criteria used is when the appearance of the aerostat changes so that the wrinkles become deeper and longer, extending into the front face of the aerostat; and the cross-section of seam becomes a v-shape, as opposed to the rounded shape that characterizes a fully inflated aerostat. At this time the aerostat will still physically float, but will no longer have an aesthetically pleasing appearance. The number of days between initial inflation and the loss of aesthetic appearance described above is reported as the floating time of the aerostat.

From the above disclosure of the general principles of the present invention and the preceding detailed description, those skilled in this art will readily comprehend the various modifications to which the present invention is susceptible. Therefore, the scope of the invention should be limited only by the following claims and equivalents thereof.

1. An aesthetic aerostat comprising:
(a) a first barrier film with inner and outer sides;
(b) a second barrier film with an inner and outer sides;
(c) a design printed on at least one of the outer sides of the barrier films, the design having an outer perimeter;
(d) an adhesive printed on the inner side of one of the films corresponding to being just inside of the outer perimeter of the printed design for laminating the barrier films together; and
(e) a die cut outer edge corresponding to just outside of the outer perimeter thereby forming the aesthetic aerostat.

2. The aerostat of claim 1, further comprising a valve between the barrier films extending outside the aerostat beyond the lamination.

3. The aerostat of claim 1 wherein the adhesive is chosen from a group comprising radiation curable pressure sensitive adhesives, acrylic polymers and copolymers and methacrylic polymers and copolymers.

4. The aerostat of claim 1 wherein the barrier film is chosen from a group comprising polyamide, polyester, polyolefin, nylon, polyethylene, polylactic acid, polyhydroxy butyrate-valerate and biodegradable polymers.

5. The aerostat of claim 1 wherein the aerostat has an internal volume of less than about 2000 cubic centimeters.

6. The aerostat of claim 1 wherein the adhesive has a seal strength of greater than 2000 grams per inch under a modified ASTM F88.

7. An aesthetic aerostat comprising:
(a) a first barrier film with inner and outer sides;
(b) a second barrier film with an inner and outer sides;
(c) a design printed on at least one of the outer sides of the barrier films, the design having an outer perimeter;
(d) an adhesive printed on the inner side of one of the films corresponding to being just inside of the outer perimeter of the printed design for laminating the barrier films together;
(e) a die cut outer edge corresponding to just outside of the outer perimeter thereby forming the ornate aerostat; and
(f) a valve between the barrier films extending to outside of the die cut outer edge.

8. The aerostat of claim 7 wherein the aerostat has an internal volume of less than about 2000 cubic centimeters.

9. The aerostat of claim 7 wherein the adhesive is chosen from a group comprising radiation curable pressure sensitive adhesives, acrylic polymers and copolymers and methacrylic polymers and copolymers.

10. The aerostat of claim 7 wherein the barrier film is chosen from a group comprising polyamide, polyester, polyolefin, nylon, polyethylene, polylactic acid, polyhydroxy butyrate-valerate and biodegradable polymers.

11. The aerostat of claim 7 wherein the adhesive has a seal strength of greater than 2000 grams per inch under a modified ASTM F88.

12. An aesthetic aerostat comprising:
(a) a first barrier film with inner and outer sides;
(b) a second barrier film with an inner and outer sides, wherein the barrier film are chosen from a group comprising polyamide, polyester, polyolefin, nylon, polyethylene, polylactic acid, polyhydroxy butyrate-valerate and biodegradable polymers;
(c) a design printed on at least one of the outer sides of the barrier films, the design having an outer perimeter;
(d) an adhesive printed on the inner side of one of the films corresponding to being just inside of the outer perimeter of the printed design for laminating the barrier films together, wherein the adhesive is chosen from a group comprising radiation curable pressure sensitive adhesives, acrylic polymers and copolymers and methacrylic polymers and copolymers;
(e) a die cut outer edge corresponding to just outside of the outer perimeter thereby forming the ornate aerostat; and
(f) a valve between the barrier films extending outside the aerostat beyond the lamination.

13. The aerostat of claim 12 wherein the aerostat has an internal volume of less than about 2000 cubic centimeters.

14. The aerostat of claim 12 wherein the adhesive has a seal strength of greater than 2000 grams per inch under a modified ASTM F88.

15. A method of making an aesthetic aerostat from a continuous web, comprising:
(a) unwinding first and second barrier films from continuous rolls with inner and outer sides;
(b) printing on at least one of the outer sides of the barrier films, the design having an outer perimeter;
(c) printing an adhesive on the inner side of one of the films corresponding to being just inside of the outer perimeter of the printed design for laminating the barrier films together;
(d) curing the adhesive;
(e) laminating the barrier films together along the printed adhesive;
(f) die cutting the aerostat just outside the outer perimeter; and
(g) picking the aerostat out of the continuous web.

16. The method of claim 15, further comprising placing a valve between the barrier films extending outside the aerostat beyond the lamination.

17. The method of claim 15 wherein the adhesive is chosen from a group comprising radiation curable pressure sensitive adhesives, acrylic polymers and copolymers and methacrylic polymers and copolymers.

18. The method of claim 15 wherein the barrier film is chosen from a group comprising polyamide, polyester, polyolefin, nylon, polyethylene, polylactic acid, polyhydroxy butyrate-valerate and biodegradable polymers.

19. The aerostat of claim 15 wherein the aerostat has an internal volume of less than about 2000 cubic centimeters.

20. The aerostat of claim 15 wherein the adhesive has a seal strength of greater than 2000 grams per inch under a modified ASTM F88.
